(19) United States
(12) Patent Application Publication
(10) Pub. No.: US 2006/0242675 A1
(43) Pub. Date: Oct. 26, 2006

(54) Return path management system and method

(76) Inventor: Zino Lee, Seoul (KR)

Correspondence Address: HOFFMANN & BARON, LLP, 6900 JERICHO TURNPIKE, SYOSSET, NY, 11791, US

(21) Appl. No.: 10/555,471

(22) PCT Filed: Apr. 30, 2004
(86) PCT No.: PCT/KR04/01013

§ 371 Date: Oct. 31, 2005

(30) Foreign Application Priority Data
May 1, 2003 (KR) 10-2003-0027938

(51) Int. Cl. H04N 7/173; H04N 7/20

(52) U.S. Cl. 725/105; 725/65; 725/118

(57) ABSTRACT

There is provided a return path management system and method positioned between a user television and a provider system which delivers return paths from user televisions to provider systems in a packetized form. The return path management system comprises return path server, a provider database, a user database and a content database, wherein the provider database maintains providers information depending on levels which the provider systems belong to and which determine service levels, the user database maintains users information required for users authentication, a content database maintains contents information provided from the provider systems, and the return path server receives order information, identifies a provider to whom the received order information should be delivered, determines a service level based on the level which the provider belongs to in reference to the provider database, and performs interpretation and communication packetization of the order information depending on the determined service level. The return path management system according to the present invention can satisfy various demands of providers, because the system provides services dependent upon the provider systems. In addition, the return path management system according to the present invention can relieve excessive burdens loaded to return path servers caused by indiscriminate treatment of the return paths.

### TECHNICAL FIELD OF THE INVENTION

The present invention relates to a return path management system and method. More specifically, the present invention relates a return path management system and method which provides intelligent operation of return paths.

### BACKGROUND OF THE INVENTION

Internet is widely used for opinion polls, shopping, banking, and so on. Particularly, as you may know from the word, “internet is a sea of information,” various information are exchanged and shared through the internet. The internet became the essential tools of modern life. Accompanied with rapid distribution of the internet, development of bi-directional communications using a television has widely distributed the concept of “television commerce” (T-commerce). Television is a medium to which all the classes are intimate and easily accessible including the aged and housewives who are not intimate to a computer.

FIG. 1 is a block diagram showing a conventional return path management system for T-commerce. As shown in FIG. 1, a provider system 10 provides various contents for data broadcasting to a server 20 which are managed by a broadcasting provider, and then the broadcasting provider sends the data broadcasting contents to a user television using a transmission system 30 through a satellite 40. User orders goods or services from the data displayed on the television 50 and the order information is delivered to a return path server 70 via return path physical layer 60. The return path server 70 identifies the provider from the order information and delivers the order information to the destined provider system 10 through a communication network (not shown) such as internet network.

Up to now, the return path sever 70 has a simple role to deliver the order information. For this reason, providers who are not intimate to T-commerce had disregarded the system. According to the opinion of persons who participate in the field of T-commerce, the return path server 70 was expected to treat all the processes including delivery of the order information, user authentication, and billing. However, in a case that the return path server 70 treats all the processes including delivery of the order information, user authentication, and billing, the capability of the server 70 should be very high, and delay of the transaction of the order may be caused. This may be an obstacle to both the providers and the users. Further, the return path server 70 does not satisfy various demands of the providers. For example, let us suppose that a provide A has proficient knowledge and systems in user authentication, billing and call processing as well as the electronic commerce. In this case, the capability of the provider A overlaps with the services provided by the return path server 70. As thus, the return path server 70 wastes its capability on performing unnecessary tasks and the provider system becomes useless. This is disadvantageous to the provider as well as the manager of the return path server.

### SUMMARY OF THE INVENTION

Therefore, in order to avoid the above disadvantages, an object of the present invention is to provide a return path management system which provides intelligent plans to meet the various demands of the providers, and which highly reduces excessive burdens loaded to the return path server.

Another object of the present invention is to provide a return path management system which provides intelligent operation of return paths in which the system treats return paths based on levels to which provider systems belongs.

The above objects and others which will be described in the detailed description of the present invention can be accomplished by provision of a return path management system which delivers return paths from user televisions to provider systems in a packetized form, comprising a return path server, a provider database, a user database and a content database, wherein the provider database maintains providers information depending on levels which the provider systems belong to and which determine service levels, the user database maintains users information required for users authentication, a content database maintains contents information provided from the provider systems, and the return path server receives order information, identifies a provider to whom the received order information should be delivered, determines a service level based on the level which the provider belongs to in reference to the provider database, and performs interpretation and communication packetization of the order information depending on the determined service level.

According to the preferred embodiment of the present invention, there is provided a return path management system, wherein the provider database maintains the providers information by categorizing each of the provider systems into any one of four levels based on the service level requested from the provider, and

the return path server identifies the provider and determines the service level referring to the received order information and the provider database, and then,

if the user's order is determined to be delivered to the provider system belonging to a first level, the return path server identifies an uniform resource locator (URL) address of the provider system from the order information and delivers the received order information to the provider system in a packetized form,

if the user's order is determined to be delivered to the provider system belonging to a second level, the return path server performs a user authentication referring to the order information and the user database, and delivers a user authentication information in combination with the received order information to the provider system in a packetized form,

if the user's order is determined to be delivered to the provider system belonging to a third level, the return path server performs a user authentication referring to the order information and the user database, extracts a billing information from the order information to perform a billing processing in contact with a financial server as a representative of the provider, and delivers a user authentication information and a billing processing information in combination with the received order information to the provider system in a packetized form, or

if the user's order is determined to be delivered to the provider system belonging to a fourth level, the return path server performs a user authentication referring to the order information and the user database, extracts a billing information from the order information to perform a billing processing in contact with a financial server as a representative of the provider, delivers a user authentication information and a billing processing information in combination with the received order information to the provider system in a packetized form, and updates the content database referring to contents received from the provider system.

### BRIEF DESCRIPTION OF THE DRAWINGS

FIG. 1 is a schematic block diagram showing a conventional return path management system used in television commerce.

FIG. 2 is a schematic block diagram illustrating a return path management system in accordance with the present invention.

FIG. 3 is a flow chart illustrating a return path management system in accordance with the present invention.

FIG. 4 is a block diagram showing a preferred embodiment of an order processing system in accordance with the present invention, in which the order information from the user is delivered to the provider system belonging to a first level.

FIG. 5 is a block diagram showing a preferred embodiment of an order processing system in accordance with the present invention, in which the order information from the user is delivered to the provider system belonging to a second level.

FIG. 6 is a block diagram showing a preferred embodiment of an order processing system in accordance with the present invention, in which the order information from the user is delivered to the provider system belonging to a third level.

FIG. 7 is a block diagram showing a preferred embodiment of an order processing system in accordance with the present invention, in which the order information from the user is delivered to the provider system belonging to a fourth level.

FIG. 8 shows a preferred embodiment of a communication packet delivered from a return path management system to a provider system.

FIG. 9 is a block diagram showing a preferred embodiment of a return path management having a hierarchy structure, in accordance with the present invention.

### DETAILED DESCRIPTION OF THE INVENTION

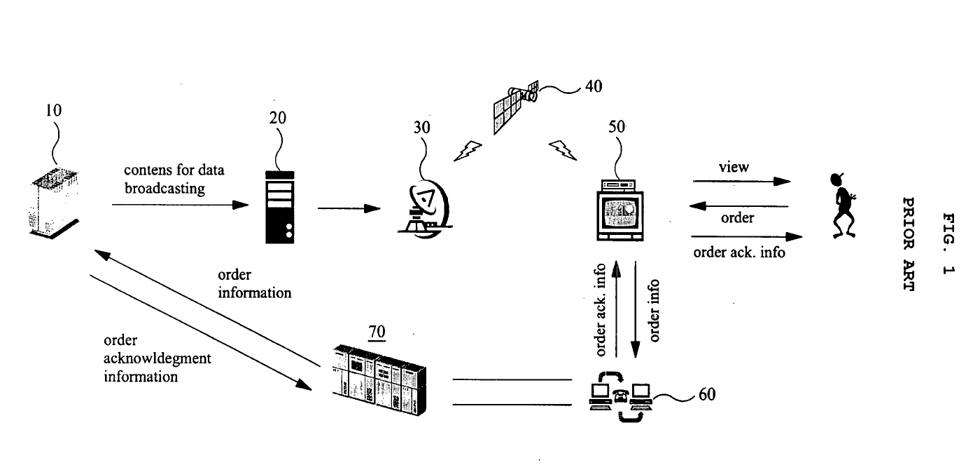

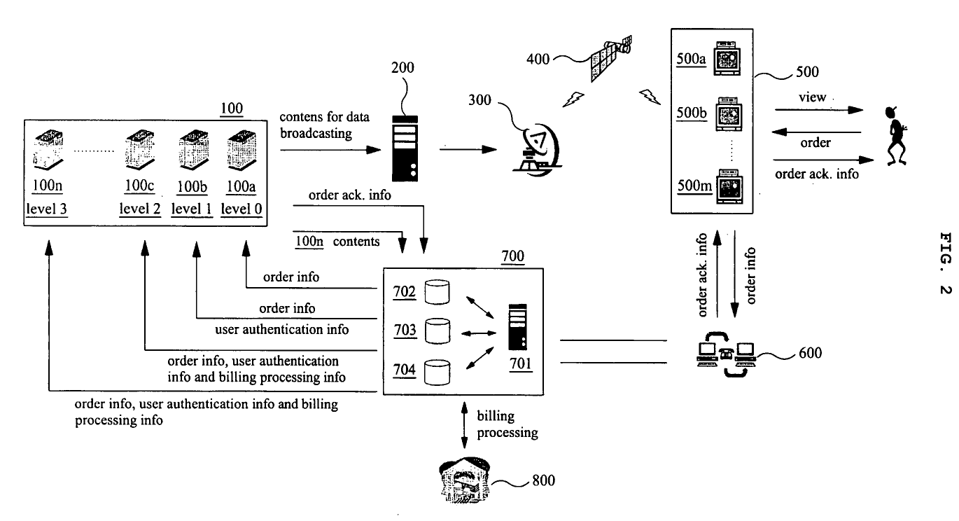

FIG. 2 is a schematic block diagram illustrating a return path management system in accordance with the present invention. A plurality of provider systems 100a-100n (totally “100”) and user televisions 500a-500n (totally, “500”) are connected to a return path management system 700. The provider systems 100 are leveled according to service levels requested from the providers. In FIG. 1, the provider system 100a is supposed to belong to a first level (“LEVEL 0”), the provider system 100b to a second level (“LEVEL 1”), the provider system 100c to a third level (“LEVEL 2”) and the provider system loon to a fourth level (“LEVEL 3”), respectively. IP addresses of the provider systems 100 and service levels of which the providers requested the return path management system 700 are maintained in a provider database 702.

Let us suppose that a user would like to order a good displayed on user television 500. The user transmits an order information to the return path management system 700. Generally, the order information includes an information about the good to be purchased, an information about a provider from whom the good is provided, an information of user identification (for example, name and address of the user), a billing-related information, or combination thereof. The order information is transmitted to a return path server 701 of the return path management system 700, and there, the return path server 701 identifies from the order information the provider to whom the order information is delivered, and determines a service level in reference to the provider database 702 in which the provider systems are categorized into various levels depending on the request of the providers. Thereafter, the return path server 701 performs preliminary works to the order information based on the service level to which the provider belongs and delivers the order information to the provider system 100.

Herein, the service levels are preferably categorized into four levels as follows:

A first level is to deliver the order information received from the user to the provider system without any works. That is, if the received order information is required to be delivered to the provider system 100a belonging to the first level, the return path management system 700 plays a simple role to deliver the received order information to the provider system 100a. In this case, the role of the return path management system is a transaction gateway or a transaction hub. As a result, the return path management system 700 does not make sure whether the user identification information or the billing-related information is included in the order information or not. The provider system 100a performs by himself a user authentication and a billing processing, and transmits to the user an order acknowledgement information including user authentication, fee payment, goods delivery, and so on. Herein, the order acknowledgement information can be directly transmitted to the user. Preferably it is delivered through the return path management server 700, because the protocol of the user televisions 500 is different from a computer.

A second level is to deliver the order information received from the user to the provider system after a user authentication has been performed. That is, if the received order information is required to be delivered to the provider system 100b belonging to the second level, the return path management system 700 performs a user authentication to the received order information, referring to a user database 703. Specifically, decoding of the order information, identification of the user and authorization to the user are successively performed. Herein, if data required for the user authentication are missing in the order information received from the user, the return path management system 700 requests the user of the missed data. If the user authentication has been successfully performed, then the return path management system 700 delivers the user authentication information in combination with the received order information to the provider system 100b. Due to the delivery of the user authentication information, the provider system 100b does not perform any works required for the user authentication.

A third level is to deliver the order information received from the user to the provider system after a billing processing as well as a user authentication has been performed. That is, if the received order information is required to be delivered to the provider system 100c belonging to the third level, the return path management system 700 performs a user authentication to the received order information, referring to a user database 703. In addition, the return path management system 700 extracts a billing-related information from the interpretation of the order information and performs a billing processing as a representative of the provider. Herein, if data required for the billing processing are missing in the order information received from the user, the return path management system 700 requests the user of the missed data. And, if billed fee is missing in the order information received from the user, the return path management system 700 requests the provider system 100c of the data. Thereafter, the return path management system 700 contacts with a financial server 800 to perform a billing processing. If the billing processing as well as the user authentication has been successfully performed, then the return path management system 700 delivers the billing processing information and the user authentication information in combination with the received order information to the provider system 100c. The provider system 100c performs neither the user authentication nor the billing processing.

A fourth level is to perform management of contents received from the provider in addition to delivery of the order information, the user authentication, the billing processing. That is, if the received order information is required to be delivered to the provider system 100n belonging to the third level, the return path management system 700 updates a content database 704 referring to contents newly received from the provider, as well as performing delivery of the received order information, the user authentication and the billing processing. In this case, the return path management 700 fills a role of a server of the provider.

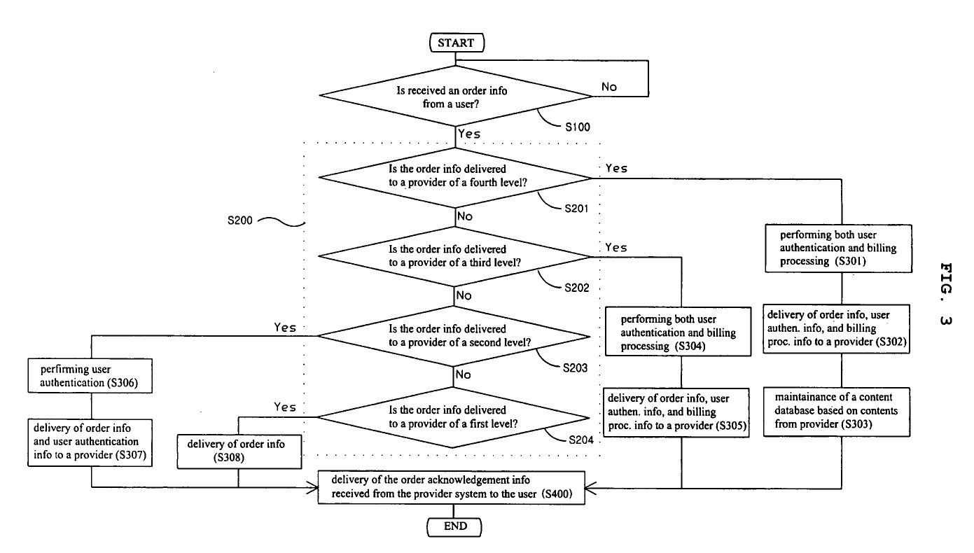

FIG. 3 is a flow chart illustrating the return path management in accordance with the present invention.

The return path management system checks whether an order information from a user is received or not (S100). If the order information from the user is received, the return path management system determines, referring to a provider database, the level of the provider system to which the received order information is delivered (S200). If the received order information is required to be delivered to the provider system belonging to a fourth level (S201), the return path management system performs a user authentication and a billing processing (S301) and delivers the user authentication information and the billing processing information as well as the order information to the provider system (S302). In addition, the return path management system manages contents from the provider system based on a content database (S303). An order acknowledgement information received from the provider system is transmitted to the user (S400). If the received order information is required to be delivered to the provider system belonging to a third level (S202), the return path management system performs a user authentication and a billing processing (S304) and delivers the user authentication information and the billing processing information as well as the order information to the provider system (S305). Thereafter, an order acknowledgement information received from the provider system is transmitted to the user (S400). If the received order information is required to be delivered to the provider system belonging to a second level (S203), the return path management system performs a user authentication (S306) and delivers the user authentication information to the provider system (S307). Thereafter, an order acknowledgement information received from the provider system is transmitted to the user (S400). If the received order information is required to be delivered to the provider system belonging to a first level (S204), the return path management system simply delivers the received order information to the provider system (S308). Thereafter, an order acknowledgement information received from the provider system is transmitted to the user (S400).

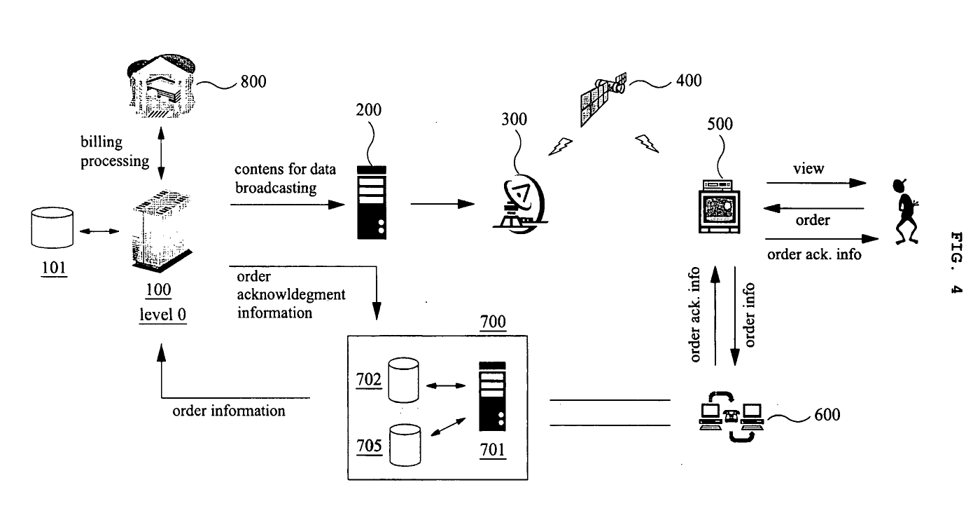

FIG. 4 is a block diagram showing a preferred embodiment of an order processing system in accordance with the present invention, in which the order information from the user is delivered to the provider system belonging to a first level. A provider system belonging to a first level 100 provides data broadcasting contents to a server 200 managed under a broadcasting provider, and the broadcasting provider transmits data broadcasting signals to a user television 500 using a transmission system 300 through a satellite 400. The user orders goods or services referring to the data displayed on the user television 500, and an order information is transmitted to a return path management system 700 through a physical layer 600. A return path server 701 of the return path management system 700 identifies a provider system 100 to which the order information should be delivered, referring to a provider database 702. If the order information is required to be delivered to the provider system 100 belonging to a first level, the return path server 701 delivers the order information to the provider system 100 through an internet network (not shown). The provider system 100 performs by himself a user authentication to the received order information referring to a user database 101, and extracts a billing information from interpretation of the order information and contacts with a financial server 800 to process a fee payment. Thereafter, the provider system 100 transmits an order acknowledgement information to return path management system 700. The return path management system 700 transforms the received order acknowledgement information to a suitable form to display it on the user television 500. In this case, the return path management system 700 may further comprise an order database 705 which manages the order information from the user and the order acknowledgement information from the provider system in order to ensure safe transaction. In the order processing system shown in FIG. 4, the provider is responsible for a user authentication, a billing processing, and delivery of goods, and the return path management system 700 acts as a transaction gateway or a transaction hub that simply delivers the order information from a user to a provider and the order acknowledgement information from the provider to the user. For this reason, the order processing system is adequate for the providers equipped with additional systems for performing the user authentication, and the billing.

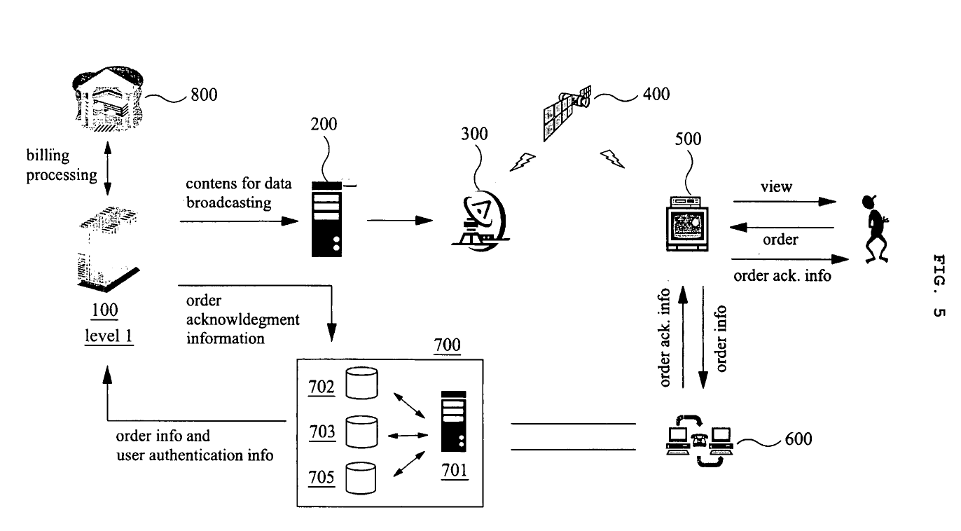

FIG. 5 is a block diagram showing a preferred embodiment of an order processing system in accordance with the present invention, in which the order information from the user is delivered to the provider system belonging to a second level. A provider system belonging to a second level 100 provides data broadcasting contents to a server 200 managed under a broadcasting provider, and the broadcasting provider transmits data broadcasting signals to a user television 500 using a transmission system 300 through a satellite 400. The user orders goods or services referring to the data displayed on the user television 500, and an order information is transmitted to a return path management system 700 through a physical layer 600. A return path server 701 of the return path management system 700 identifies a provider system 100 to which the order information should be delivered, referring to a provider database 702. If the order information is required to be delivered to the provider system 100 belonging to a second level, the return path server 701 performs a user authentication to the received order information referring to the user database 702. If data required for the user authentication are missing in the order information received from the user, the return path management system 700 requests the user of the missed data. A smart card may be used for the user authentication. If the user authentication has been successfully performed, then the return path server 701 delivers the user authentication information in combination with the received order information to the provider system 100 through an internet network (not shown). Because the user authentication has been already performed by the return path management system 700, the provider system 100 does not perform any works required for the user authentication. The provider system 100 extracts by himself a billing information from interpretation of the order information and contacts with a financial server 800 to process a billing. Thereafter, the provider system 100 transmits an order acknowledgement information to return path management system 700. The return path management system 700 transforms the received order acknowledgement information to a suitable form to display it on the user television 500. As mentioned above, the return path management 700 may further comprise an order database 705 which manages the order information from the user and the order acknowledgement information from the provider system in order to ensure safe transaction. In the order processing system shown in FIG. 5, the provider is responsible for the billing and the delivery of goods, and the return path management system 700 for the user authentication, the delivery of the order information and the delivery of the order acknowledgement information. For this reason, the order processing system is adequate for the providers equipped with a billing system and a good delivery system, and no system required for a user authentication.

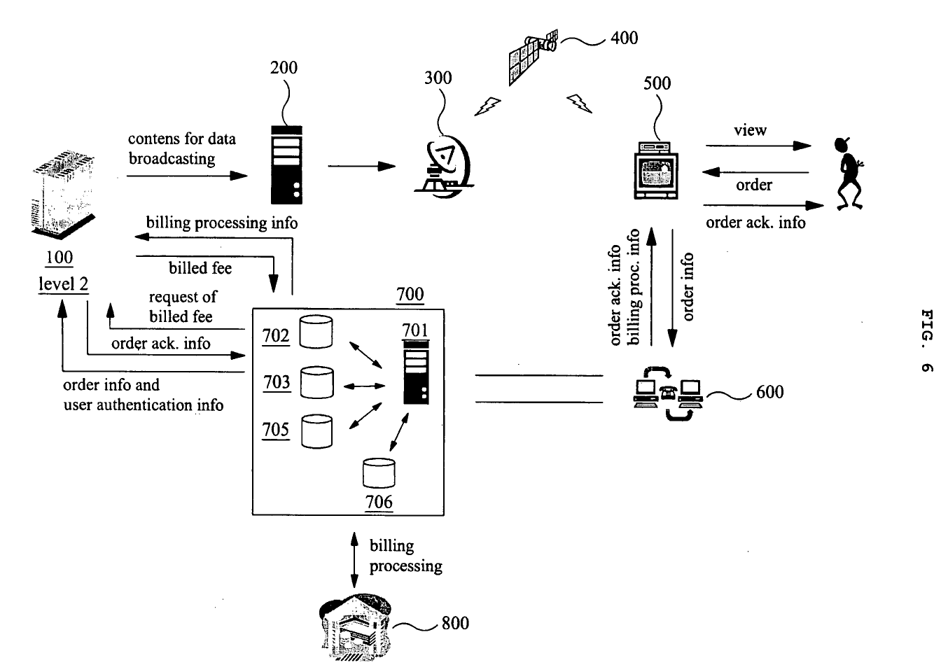

FIG. 6 is a block diagram showing a preferred embodiment of an order processing system in accordance with the present invention, in which the order information from the user is delivered to the provider system belonging to a third level. A provider system belonging to a third level 100 provides data broadcasting contents to a server 200 managed under a broadcasting provider, and the broadcasting provider transmits data broadcasting signals to a user television 500 using a transmission system 300 through a satellite 400. The user orders goods or services referring to the data displayed on the user television 500, and an order information is transmitted to a return path management system 700 through a physical layer 600. A return path server 701 of the return path management system 700 identifies a provider system 100 to which the order information should be delivered, referring to a provider database 702. If the order information is required to be delivered to the provider system 100 belonging to a third level, the return path server 701 performs both a user authentication to the received order information referring to the user database 702 and a billing processing in contact with a financial server 800. If data required for the user authentication and/or the billing processing are missing in the order information received from the user, the return path management system 700 requests the user of the missed data. If billed fee is missing in the order information received from the user, the return path management system 700 requests the provider system 100 of the data. If the user authentication and the billing processing have been successfully performed, then the return path server 701 delivers the user authentication information and the billing processing information in combination with the received order information to the provider system 100 through an internet network (not shown). Because the user authentication information and fee payment have been already performed by the return path management system 700, the provider system 100 does not perform any works required for the user authentication and the fee payment. The provider system 100 has only to manage application-related information such as updates of new catalogue. The billing processing information and the order acknowledgement information from the provider system 100 are displayed through the return path management system 700 on the user television 500. As mentioned above, the return path management 700 may further comprise an order database 705 which manages the order information from the user and the order acknowledgement information from the provider system in order to ensure safe transaction. Further, the return path management 700 may further comprise a billing database 706 which manages the billing-related information. In the order processing system shown in FIG. 6, the provider is responsible for goods delivery, and the return path management system 700 for the user authentication, the billing processing, and the delivery of the order information and the delivery of the order acknowledgement information. For this reason, the order processing system is adequate for the providers equipped with a logistic system which checks the distribution of goods. Neither a system for the user authentication nor a system for the billing processing is required for the providers.

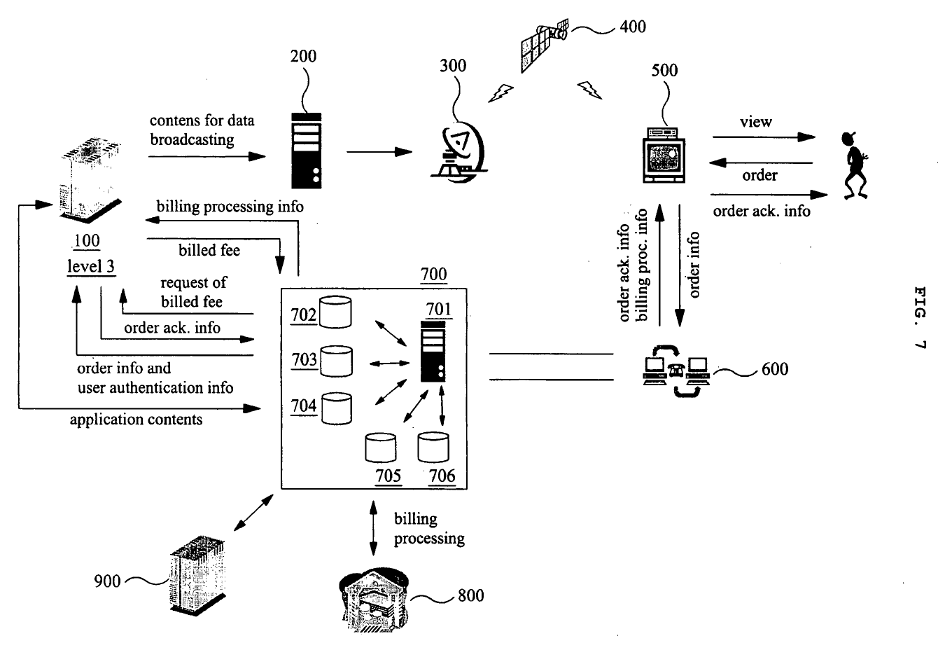

FIG. 7 is a block diagram showing a preferred embodiment of an order processing system in accordance with the present invention, in which the order information from the user is delivered to the provider system belonging to a fourth level. A provider system belonging to a fourth level 100 provides data broadcasting contents to a server 200 managed under a broadcasting provider, and the broadcasting provider transmits data broadcasting signals to a user television 500 using a transmission system 300 through a satellite 400. The user orders goods or services referring to the data displayed on the user television 500, and an order information is transmitted to a return path management system 700 through a physical layer 600. A return path server 701 of the return path management system 700 identifies a provider system 100 to which the order information should be delivered, referring to a provider database 702. If the order information is determined to be delivered to the provider system 100 belonging to a fourth level, the return path server 701 performs both a user authentication to the received order information referring to the user database 702 and a billing processing in contact with a financial server 800. If data required for the user authentication and/or the billing processing are missing in the order information received from the user, the return path management system 700 requests the user of the missed data. If billed fee is missing in the order information received from the user, the return path management system 700 requests the provider system 100c of the data. If the user authentication and the billing processing have been successfully performed, then the return path server 701 delivers the user authentication information and the billing processing information in combination with the received order information to the provider system 100 through an internet network (not shown). Because the user authentication information and the fee payment have been already performed by the return path management system 700, the provider system 100 does not perform any works required for the user authentication and the fee payment. The provider system 100 has only to manage application-related information such as updates of new catalogue. As mentioned above, the return path management 700 may further comprise an order database 705 which manages the order information from the user and the order acknowledgement information from the provider system in order to ensure safe transaction. Further, the return path management 700 may further comprise a billing database 706 which manages the billing-related information. In addition to the user authentication and the billing processing, the return path management system 700 manages, referring to a content database 704, application-related information (for example, catalogue of goods, the check of the distribution of goods, vote data or auction data) provided from the provider system 100. An order acknowledgement information from the provider system 100 is displayed through the return path management system 700 on the user television 500. If necessary, the return path management system 700 may contact with a delivery system 900 to ask delivery of goods and retrieve delivery status. In the order processing system shown in FIG. 7, the return path management system 700 is responsible for the user authentication, the billing processing, provision of the information about the degree of goods delivery, management of the application-related information required for the order processing, the delivery of the order information and the delivery of the order acknowledgement information. The provider only has to check basic items required for transactions in off lines such as damage to goods, delay of goods delivery, and distribution of new catalogue to return path management system 700. For this reason, the order processing system is adequate for small shop managers and SOHO founders.

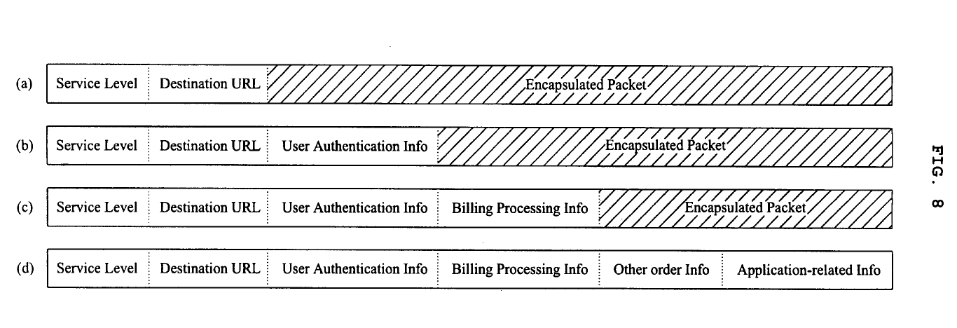

FIG. 8 shows a preferred embodiment of communication packets delivered from a return path management system to a provider system. As shown in FIG. 8, communication packet models are dependent upon the service levels. That is, the degree of the interpretation of the order information of the return path management system depends on the service levels.

Specifically, in a case of a provider belonging to a first level, the return path management system identifies an URL of the provider system from the order information received from the user. It is not confirmed whether information required for a user authentication or a billing processing is included in the order information or not. As a result, the communication packet delivered to the provider system contains a service level of the provider, a destination URL of the provider system and an encapsulated packet of the order information (FIG. 8a).

In a case of a provider belonging to a second level, the return path management system identifies a user authentication information as well as an URL of the provider system from the order information received from the user. It is not confirmed whether information required for a billing processing is included in the order information or not. As a result, the communication packet delivered to the provider system contains a service level of the provider, a destination URL of the provider system, a user identification information and an encapsulated packet of the order information (FIG. 8b). Likewise, in a case of a provider belonging to a third level, the return path management system identifies a user authentication information and a billing-related information as well as an URL of the provider system from the order information received from the user. As a result, the communication packet delivered to the provider system contains a service level of the provider, a destination URL of the provider system, a user identification information, a billing-processing information and an encapsulated packet of the order information (FIG. 8c). In a case of a provider belonging to a third level, the communication packet delivered from the return path management system to the provider system contains a service level of the provider, a destination URL of the provider system, a user identification information, a billing-processing information, other order-related information (for example, goods information, questions asked from the user) and application-related information (FIG. 8d).

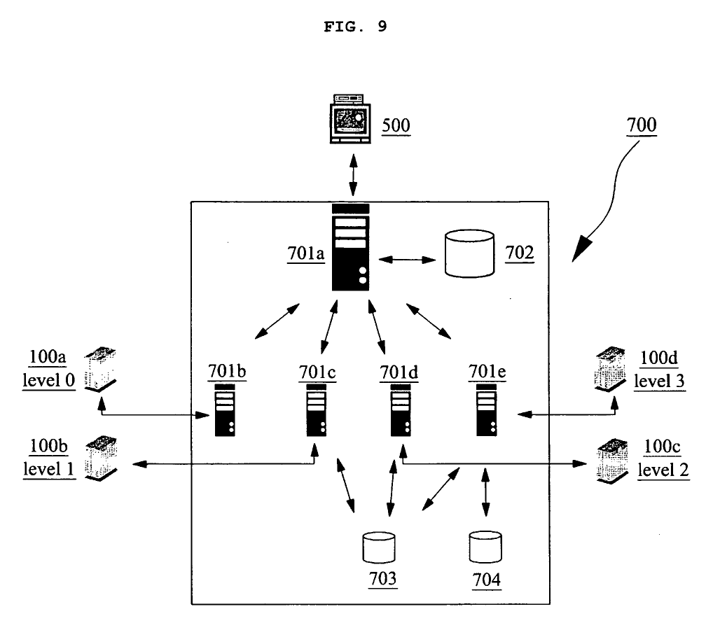

In a meanwhile, the return path management system according to the present invention may be constituted in a hierarchy structure. FIG. 9 is a block diagram showing a preferred embodiment of a return path management having a hierarchy structure. The return path management system 700 comprises a return path server 701a and four transaction servers 701b to 701e coupled to the return path server 701a, each of which is assigned to treat order information belonging to a different level. For example, the transaction server 701b may be assigned to treat the order information to be delivered to providers belonging to a first level, the transaction server 701c, 701d and 701e to treat the order information to be delivered to providers belonging to a second, a third and a fourth levels, respectively. Specifically, the return path server 701a receives an order information from a user, identifies a provider system to which the order information is required to be delivered and determines a level to which the identified provider system belongs, referring to a provider system 702. If a provider system 100a belonging to a first level is determined to treat the received order information, the return path server 701a transmits the received order information to the transaction server 701b. The transaction server 701b delivers the communication packet shown in FIG. 8a to the provider system 100a. Thereafter, the transaction server 701b transmits the order acknowledgement information received from the provider system 100a to the return path server 701a, and the return path server 701a transforms the received order acknowledgement information in a format to be displayed on a user television 500 and delivers it to the user television 500. If a provider system 100b belonging to a second level is to treat the received order information, the return path server 701a transmits the received order information to the transaction server 701c. The transaction server 701c performs a user authentication, and it delivers the communication packet shown in FIG. 8b to the provider system 100b. If a provider system 100c belonging to a third level is to treat the received order information, the return path server 701a transmits the received order information to the transaction server 701d. The transaction server 701d performs a user authentication and a billing processing, and it delivers the communication packet shown in FIG. 8c to the provider system 100c. If a provider system 100d belonging to a fourth level is to treat the received order information, the return path server 701a transmits the received order information to the transaction server 701e. The transaction server 701e performs a user authentication and a billing processing, and it delivers the communication packet shown in FIG. 8d to the provider system 100d. In addition, the transaction server 701e requests the provider system 100d of application-related information, updates a content database 704 based on the received application-related information. If necessary, delivery of goods obtained by contacting delivery systems (not shown) can be maintained by a delivery database (not shown). The return path management system 700 having a hierarchy structure separates determination of the service level and processing of communication packets, thereby increasing the efficiency of the treatment of the return paths.

The system according to the present invention can be also applicable to bi-directional cable broadcasting, bi-directional terrestrial broadcasting as well as bi-directional satellite broadcasting exemplified in the above. Further, the system can be applicable to various applications including shopping services, ticketing services, bi-directional advertisement services, voting services, lottery services and auction services. In addition, the provider systems are categorized into four levels. However, this exemplifies most preferred embodiment of the present invention, and the scope of the present invention are not limited thereto. And the system can integrate other devices such as PDA, mobile phones and computers as well as the digital television. In other words, the return path management system can treat return paths transmitted to PDA, mobile phones and computers by employing contents-conversion server which converts the return path signals in a format to be readable by the return path management system.

### INDUSTRIAL APPLICABILITY

The return path management system according to the present invention can satisfy various demands of providers, because the system provides services dependent upon the provider systems. In addition, the return path management system according to the present invention can relieve excessive burdens loaded to return path servers caused by indiscriminate treatment of the return paths. Particularly, the return path management system having a hierarchy structure separates determination of the service level and processing of communication packets, which increase the efficiency of the treatment of return paths.

1. A return path management system which delivers return paths from user televisions to provider systems in a packetized form, comprising a return path server, a provider database, a user database and a content database, wherein the provider database maintains providers information depending on levels which the provider systems belong to and which determine service levels, the user database maintains users information required for users authentication, a content database maintains contents information provided from the provider systems, and the return path server receives order information, identifies a provider to whom the received order information should be delivered, determines a service level based on the level which the provider belongs to in reference to the provider database, and performs interpretation and communication packetization of the order information depending on the determined service level.

2. The return path management system as set forth in claim 1, wherein the provider database maintains the providers information by categorizing each of the provider systems into any one of four levels based on the service level requested from the provider, and
the return path server identifies the provider and determines the service level referring to the received order information and the provider database, and then,
if the user's order is determined to be delivered to the provider system belonging to a first level, the return path server identifies an URL address of the provider system from the order information and delivers the received order information to the provider system in a packetized form,
if the user's order is determined to be delivered to the provider system belonging to a second level, the return path server performs a user authentication referring to the order information and the user database, and delivers a user authentication information in combination with the received order information to the provider system in a packetized form,
if the user's order is determined to be delivered to the provider system belonging to a third level, the return path server performs a user authentication referring to the order information and the user database, extracts a billing information from the order information to perform a billing processing in contact with a financial server as a representative of the provider, and delivers a user authentication information and a billing processing information in combination with the received order information to the provider system in a packetized form, or if the user's order is determined to be delivered to the provider system belonging to a fourth level, the return path server performs a user authentication referring to the order information and the user database, extracts a billing information from the order information to perform a billing processing in contact with a financial server as a representative of the provider, delivers a user authentication information and a billing processing information in combination with the received order information to the provider system in a packetized form, and updates the content database referring to contents received from the provider system.

3. The return path management system as set forth in claim 2, wherein if the user's order is determined to be delivered to the provider system belonging to a first level, a communication packet delivered from the return path management system to the provider system contains a service level of the provider, a destination uniform resource locator (URL) of the provider system and an encapsulated packet of the order information; if the user's order is determined to be delivered to the provider system belonging to a second level, a communication packet delivered from the return path management system to the provider system contains a service level of the provider, a destination URL of the provider system, a user identification information and an encapsulated packet of the order information; if the user's order is determined to be delivered to the provider system belonging to a third level, a communication packet delivered from the return path management system to the provider system contains a service level of the provider, a destination URL of the provider system, a user identification information, a billing-processing information and an encapsulated packet of the order information; and if the user's order is determined to be delivered to the provider system belonging to a fourth level, a communication packet delivered from the return path management system to the provider system contains a service level of the provider, a destination URL of the provider system, a user identification information, a billing-processing information, other order-related information and application-related information.

4. The return path management system as set forth in claim 1, wherein the return path management system has a hierarchy structure such that determination of the service level to the order information received from the user and processing of communication packets delivered from the return path management system to the provider system are separately performed.

5. The return path management system as set forth in claim 4, comprising a return path server and four transaction servers coupled to the return path server wherein the return path server receives an order information from the user, identifies the provider system to which the order information is required to be delivered and determines the level to which the identified provider system belongs, referring to the provider system, and a first transaction server of the four transaction servers treats the order information to be delivered to the provider system belonging to a first level, a second transaction server of the four transaction servers treats the order information to be delivered to the provider system belonging to a second level in which a user authentication is performed referring to the user database, a third transaction server of the four transaction servers treats the order information to be delivered to the provider system belonging to a third level in which a user authentication is performed referring to the user database and a billing processing is performed in contact with a financial server, and a fourth transaction server of the four transaction servers treats the order information to be delivered to the provider system belonging to a fourth level in which a user authentication is performed referring to the user database, a billing processing is performed in contact with a financial server, and an update of contents is performed referring to the content database.

6. A return path management method, comprising:
a) providing a return path management system comprised of a provider database which maintains providers information depending on service levels of which the provider requests, in which the return path management system receives order information from a user, identifies a provider to whom the received order information should be delivered, determines a service level based on the level which the provider belongs to in reference to the provider database, and providing the determined service level;
b) determining whether an order information from a user is received or not;
c) if an order information from a user is received, identifying a provider to whom the received order information should be delivered, followed by determination of a service level based on the level which the provider belongs to in reference to the provider database;
d) performing interpretation and communication packetization of the order information depending on the determined service level.

7. The return path management method as set forth in claim 6, wherein if the user's order is determined to be delivered to the provider system belonging to a first level, the system identifies an URL address of the provider system from the order information and delivers the received order information to the provider system in a packetized form,
if the user's order is determined to be delivered to the provider system belonging to a second level, the return path server performs a user authentication referring to the order information and the user database, and delivers a user authentication information in combination with the received order information to the provider system in a packetized form,
if the user's order is determined to be delivered to the provider system belonging to a third level, the return path server performs a user authentication referring to the order information and the user database, extracts a billing information from the order information to perform a billing processing in contact with a financial server as a representative of the provider, and delivers a user authentication information and a billing processing information in combination with the received order information to the provider system in a packetized form, or if the user's order is determined to be delivered to the provider system belonging to a fourth level, the return path server performs a user authentication referring to the order information and the user database, extracts a billing information from the order information to perform a billing processing in contact with a financial server as a representative of the provider, delivers a user authentication information and a billing processing information in combination with the received order information to the provider system in a packetized form, and updates the content database referring to contents received from the provider system.

8. The return path management method as set forth in claim 6, wherein the return path management system has a hierarchy structure such that determination of the service level to the order information received from the user and processing of communication packets delivered from the return path management system to the provider system are separately performed.

9. The return path management method as set forth in claim 8, wherein the return path management system comprises a return path server and four transaction servers coupled to the return path server in which the return path server receives an order information from the user, identifies the provider system to which the order information is required to be delivered and determines the level to which the identified provider system belongs, referring to the provider system, and a first transaction server of the four transaction servers treats the order information to be delivered to the provider system belonging to a first level, a second transaction server of the four transaction servers treats the order information to be delivered to the provider system belonging to a second level in which a user authentication is performed referring to the user database, a third transaction server of the four transaction servers treats the order information to be delivered to the provider system belonging to a third level in which a user authentication is performed referring to the user database and a billing processing is performed in contact with a financial server, and a fourth transaction server of the four transaction servers treats the order information to be delivered to the provider system belonging to a fourth level in which a user authentication is performed referring to the user database, a billing processing is performed in contact with a financial server, and an update of contents is performed referring to the content database.
